(19) United States
(12) Patent Application Publication
(10) Pub. No.: US 2017/0287626 A1
(43) Pub. Date: Oct. 5, 2017

(54) COIL ASSEMBLY FOR WIRELESS POWER TRANSFER HAVING A SHAPED FLUX-CONTROL BODY

(71) Applicant: TYCO ELECTRONICS CORPORATION, Berwyn, PA (US)

(72) Inventors: Jason Larson, San Lorenzo, CA (US); Mudhafar Hassan-Ali, Menlo Park, CA (US); James Toth, San Carlos, CA (US); Ting Gao, Palo Alto, CA (US); Jialing Wang, Mountain View, CA (US)

(21) Appl. No.: 15/209,889

(22) Filed: Jul. 14, 2016

Related U.S. Application Data
(60) Provisional application No. 62/316,111, filed on Mar. 31, 2016.

(51) Int. Cl. H01F 27/28; H02J 7/02; H01F 38/14

(52) U.S. Cl. CPC H01F 27/2885; H01F 27/2804; H01F 38/14; H02J 7/025; H01F 2027/2809

(57) ABSTRACT

Coil assembly including a flux-control body having a magnetic material and a body side. The flux-control body includes a shield wall that defines a coil channel of the flux-control body that opens along the body side to an exterior of the flux-control body. The coil assembly also includes an electrical conductor positioned within the coil channel. The electrical conductor forms a power-transfer coil having co-planar windings that are configured to generate a magnetic flux within a spatial region that is adjacent to the body side. Adjacent windings are separated by the shield wall of the flux-control body. The shield wall controls a distribution of the magnetic flux experienced within the spatial region.

### CROSS-REFERENCE TO RELATED APPLICATION

The present application claims the benefit of U.S. Provisional Application No. 62/316,111, filed on Mar. 31, 2016, which is incorporated herein by reference in its entirety.

### BACKGROUND

The subject matter herein relates generally to wireless power transfer through inductive coupling of coil assemblies.

Wireless power transfer, in which electrical power is transferred from one device to another device without using interconnecting wires, provides a convenient and safe method for charging devices. In light of the advantages, more and more devices are being configured for wireless power transfer (also referred to as wireless energy transfer). A conventional wireless power transfer system typically includes a power transmitter having one or more coils and a receiving device that also includes one or more coils. The receiving device may be, for example, a phone, a watch, an electric toothbrush, an implantable medical device, or a radio-frequency identification (RFID) tag. Although many devices that are configured for charging through wireless power transfer are small, larger and less portable devices may also be charged through wireless power transfer. For example, electric vehicles, such as cars and trains, may be charged.

Each of the coils includes an electrical conductor that is wound a number of times about a central axis. In some devices, the coil is a planar coil in which the electrical conductor is wound in a spiral-like manner such that the windings reside within a common coil plane. When an alternating current (AC) flows through the coil of the power transmitter, the current generates a magnetic flux (or magnetic field) that induces an alternating voltage within the coil of the receiving device that, in turn, creates an alternating current (AC) within the coil of the receiving device. The receiving device may convert the AC in the corresponding coil into direct current (DC) and supply the electrical power to a load (e.g., battery) of the receiving device. In order to efficiently transfer power, the coils are positioned adjacent to each other and at designated orientations. The efficiency of the power transfer may be enhanced through resonant inductive coupling.

Conventional coils are often positioned adjacent to a shield layer that includes magnetically permeable material, such as ferrite. The shield layer protects the coil and/or other electronic devices positioned near the coil from interference caused by the magnetic flux. In some cases, the shield layer may be configured to control a distribution (or density) of the magnetic flux that is generated by the coil of the power transmitter. For example, the shield layer may effectively increase the magnetic flux and steer the magnetic flux such that a spatial region experiences a greater magnetic flux.

Although conventional devices are capable of generating a magnetic flux distribution for supplying the electrical power as described above, it is generally desirable to increase the coupling efficiency between the coil of the power transmitter and the coil of the receiving device.

### BRIEF SUMMARY

In an embodiment, a coil assembly is provided that includes a flux-control body including a magnetic material and having a body side. The flux-control body includes a shield wall that defines a coil channel of the flux-control body that opens along the body side to an exterior of the flux-control body. The coil assembly also includes an electrical conductor positioned within the coil channel. The electrical conductor forms a power-transfer coil having co-planar windings that are configured to generate a magnetic flux within a spatial region that is adjacent to the body side. The shield wall of the flux-control body is positioned directly between adjacent windings of the power-transfer coil. The shield wall controls a distribution of the magnetic flux experienced within the spatial region.

In an embodiment, a coil assembly is provided that includes a flux-control body including a ferromagnetic material and having a body side. The flux-control body includes an outer rim section that surrounds a coil-receiving recess that opens to the body side. The coil assembly also includes an electrical conductor positioned within the coil-receiving recess and forming a power-transfer coil therein. The power-transfer coil has co-planar windings that are configured to generate a magnetic flux within a spatial region that is adjacent to the body side. The windings surround a Z-axis. The outer rim section has a contoured surface that faces in a flux-control direction having a Z-component that is parallel to the Z-axis and a XY-component. The XY-component is perpendicular to the Z-component. The contoured surface controls a distribution of the magnetic flux experienced within the spatial region.

In an embodiment, a method of manufacturing a coil assembly is provided. The method includes providing a body mold having a cavity that is shaped by interior surfaces. The method also includes injecting a composite liquid into the interior cavity. The composite liquid including a binder material and ferromagnetic particles distributed therein. The method also includes permitting the composite liquid to cure within the body mold, thereby providing a flux-control body. The flux-control body has a body side and a shield wall that defines a coil channel of the flux-control body that opens along the body side to an exterior of the flux-control body. The method also includes positioning an electrical conductor within the coil channel. The coil channel is shaped to form a power-transfer coil when the electrical conductor is positioned therein. The power-transfer coil has co-planar windings that are configured to generate a magnetic flux within a spatial region that is adjacent to the body side. The shield wall of the flux-control body is positioned directly between adjacent windings of the power-transfer coil. The shield wall controls a distribution of the magnetic flux experienced within the spatial region.

### BRIEF DESCRIPTION OF THE DRAWINGS

FIG. 1 is a schematic diagram of a wireless power transfer (WPT) system formed in accordance with an embodiment.

FIG. 2 is a cross-section of a coil assembly formed in accordance with an embodiment that may be used with the WPT system of FIG. 1.

FIG. 3 illustrates a perspective view of a cross-section of a WPT system in accordance with an embodiment that includes the coil assembly of FIG. 2.

FIG. 4 is a cross-section of a coil assembly formed in accordance with an embodiment that may be used with the WPT system of FIG. 1.

FIG. 5 is an enlarged cross-section of a portion of the coil assembly of FIG. 4.

FIG. 6 is an enlarged cross-section of a portion of a coil assembly formed in accordance with an embodiment.

FIG. 7 is a cross-section of a coil assembly formed in accordance with an embodiment that may be used with the WPT system of FIG. 1.

FIG. 8 is a flowchart illustrating a method of fabricating a coil assembly in accordance with an embodiment.

FIG. 9 illustrates different stages of the method of FIG. 8.

### DETAILED DESCRIPTION OF SPECIFIC EMBODIMENTS

Embodiments set forth herein include coil assemblies for wireless power transfer and methods of manufacturing the same. The coil assemblies may also be referred to as inductors. The coil assemblies include an electrical conductor that forms a power-transfer coil and a flux-control body that is coupled to the power-transfer coil. The power-transfer coil includes co-planar windings and is configured to generate a magnetic flux for wireless power transfer. The flux-control body may increase (a) an inductance of the power-transfer coil, (b) shield other electrical devices that are near the power-transfer coil, and/or (c) shield the power-transfer coil from other electrical devices. The flux-control body comprises a magnetic material (e.g., soft ferrite) and is shaped to affect the magnetic flux. More specifically, the flux-control body is shaped to determine a distribution of the magnetic flux that is experienced within a spatial region adjacent to the flux-control body. In particular embodiments, the magnetic material is in the form of ferromagnetic particles that are dispersed within a binder material (e.g., polymer). For example, the flux-control body may be a preformed molded or extruded body having a designated shape. In particular embodiments, the flux-control body includes a soft ferrite-loaded polymer material.

The flux-control body may comprise a composite material that is formed (e.g., molded, printed, deposited, cut, etched, and the like) to have a predetermined shape. The composite material that forms the flux-control body may include a binder material (e.g., polymer) and ferromagnetic particles that are dispersed within the binder material. The ferromagnetic particles may be provided from a ferrite powder. In some embodiments, the composite material has between 40 vol % and 60 vol % of a ferrite powder with the remainder comprising a polymer and, optionally, a lubricant additive. The ferrite powder may be, for example, a MnZn soft ferrite powder. Other magnetic powders may include NiZn soft ferrite powder or MgZn soft ferrite powder. The lubricant additive may be, for example, between 0.5 vol % and 2.0 vol %.

In particular embodiments, the ferromagnetic material (e.g., ferromagnetic particles) may have a relative magnetic permeability that is, for example, greater than 100 or greater than 200. In particular embodiments, the relative magnetic permeability is greater than 500, greater than 750, or greater than 1000. Non-limiting examples of such materials include nickel, carbon steel, soft ferrite (nickel zinc or manganese zinc), cobalt, martensitic stainless steel, ferritic stainless steel, iron, or alloys of the same.

Non-limiting examples of binder materials that may be used include polyamide resins, such as 12-nylon, 6-nylon, 6,6-nylon, 4,6-nylon, 6,12-nylon, amorphous polyamide and semiaromatic polyamide; polyolefinic resins, such as polyethylene, polypropylene and chlorinated polyethylene; polyvinylic resins, such as polyvinyl chloride, polyvinyl acetate, polyvinylidene chloride, polyvinyl alcohol and ethylene-vinyl acetate copolymers; acrylic resins, such as ethylene-ethyl acrylate copolymers and polymethyl methacrylate; acrylonitrile resins, such as polyacrylonitrile and acrylonitrile/butadiene/styrene copolymers; various types of polyurethane resins; fluororesins, such as polytetrafluoroethylene; synthetic resins called engineering plastics, such as polyacetal, polycarbonate, polyimide, polysulfone, polybutylene terephthalate, polyarylate, polyphenylene oxide, polyether sulfone, polyphenyl sulfide, polyamidoimide, polyoxybenzylene and polyether ketone; thermoplastic resins containing liquid crystal resins, such as whole aromatic polyesters; conductive polymers, such as polyacethylene; thermosetting resins, such as epoxy resins, phenol resins, epoxy-modified polyester resins, silicone resins and thermosetting acrylic resins; and elastomers, such as nitrile rubber, butadiene-styrene rubber, butyl rubber, nitrile rubber, urethane rubber, acrylic rubber and polyamide elastomers.

The flux-control body may be, for example, a molded sheet having recesses (e.g., channels) formed therein that are sized and shaped to receive the power-transfer coil. The flux-control body may be a molded ferrite sheet and/or a sintered ferrite sheet having a coil-receiving recess formed along at least one side of the sheet. In other embodiments, the flux-control body may be formed through insert-molding, two-shot molding, and/or screen-printing.

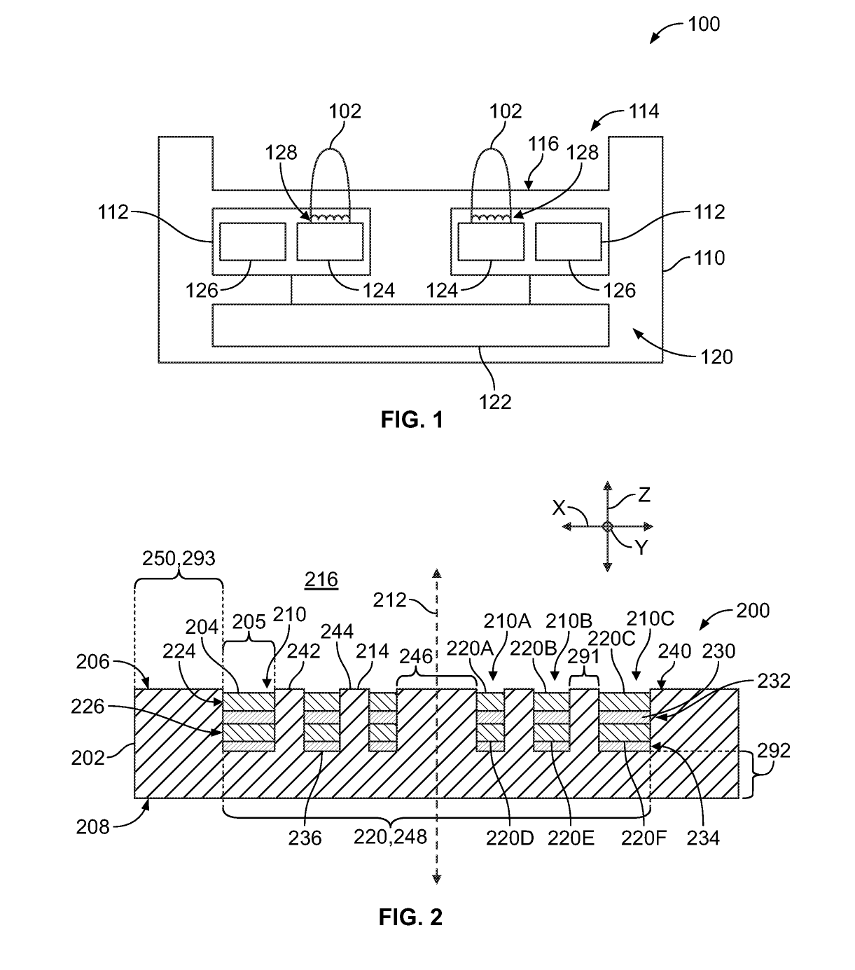

FIG. 1 is a schematic diagram of a wireless power transfer (WPT) device 100 that is configured to generate one or more magnetic fluxes (or magnetic fields) 102 for powering one or more receiving devices (not shown). In the illustrated embodiment, the WPT device 100 is configured to supply wireless power and may be referred to as a wireless power transmitter. In other embodiments, the WPT device 100 is configured to generate electrical power from induced magnetic field(s). The receiving device may be any device that is capable of receiving power (i.e., being charged) through WPT. For example, the receiving device may be a phone (e.g., smartphone), a computer (e.g., tablet, laptop, or notebook computer), a watch (e.g., smartwatch) or other wearable device, an electric toothbrush, an implantable medical device, or a radio-frequency identification (RFID) tag. In some embodiments, the WPT device 100 is configured to be stationary and the receiving device is configured to be positioned adjacent to and/or mounted on the WPT device 100. For example, a watch or a phone may be positioned onto the WPT device 100. In other embodiments, however, the WPT device 100 may be positioned adjacent to the receiving device. For example, the WPT device 100 may be positioned against a patient's body and aligned with an implanted medical device that is within the patient's body.

The WPT device 100 includes a system housing 110 and at least one WPT unit 112 that is coupled to the system housing 110. In the illustrated embodiment, the WPT device 100 includes two WPT units 112, but the WPT device 100 may include only one WPT unit 112 or more than two WPT units 112 in other embodiments. Each of the WPT units 112 is configured to generate a corresponding magnetic flux 102 for wireless power transfer. The WPT units 112 may operate in concert with each other or may operate independently from each other. As shown, the system housing 110 defines a power-transfer space 114 that is sized and shaped to receive the receiving device. The power-transfer space 114 is partially defined by a charging surface 116 of the system housing 110. In the illustrated embodiment, the receiving device is configured to rest upon the charging surface 116. Optionally, the charging surface 116 may be configured to simultaneously hold more than one receiving device. Moreover, the WPT device 100 may be configured to charge more than one type of receiving device. For example, a smartphone and a smartwatch may be simultaneously charged.

The WPT device 100 includes control circuitry 120 that is configured to control operation of the WPT device 100 for transferring power wirelessly to the receiving device. The control circuitry 120 includes the WPT units 112 and a system controller 122 that is communicatively coupled to each of the WPT units 112. Each of the WPT units 112 includes a power conversion unit 124 and a communications/control unit 126. Each power conversion unit 124 also includes a coil assembly 128. Each power conversion unit 124 may include, for example, an inverter and current/voltage detector that are operably coupled to the corresponding coil assembly 128. The coil assembly 128 may be similar to the coil assembly 200 (shown in FIG. 2), the coil assembly 300 (shown in FIG. 4), or the coil assembly 400 (shown in FIG. 6) described below.

In some embodiments, the power conversion unit 124 constitutes an analog portion of the WPT unit 112. The inverter of the power conversion unit 124 may convert a DC input to an AC waveform that drives the coil assembly 128. The current/voltage detector may monitor the current/voltage of the coil assembly 128. The communications/control unit 126 constitutes the digital logic portion of the WPT unit 112. The communications/control unit 126 may receive and decode messages from the receiving device, execute relevant power control algorithms and protocols, and drive the frequency of the AC waveform to control the wireless power transfer. The communications/control unit 126 may also interface with other subsystems of the WPT device 100. In other embodiments, the system controller 122 may also communicate with the receiving device and/or at least partially control the wireless power transfer.

During operation, the WPT device 100 and the receiving device may communicate with each other to control a charging operation in which the WPT device 100 generates the magnetic flux 102 for inducing a voltage in the coil assembly of the receiving device (not shown) that creates alternating current (AC) in the coil assembly. The communication between the WPT device 100 and the receiving device may be in accordance with known protocols, such as the Qi™ protocol or the Rezence™ protocol, or in accordance with other proprietary protocols.

Communication between the WPT device 100 and the receiving device may include a number phases. For example, the communication may include a selection phase, a ping phase, an identification-and-configuration phase, and a power-transfer phase. During the selection phase, the WPT device 100 attempts to discover and locate objects that are placed on the charging surface 116. The WPT device 100 may also attempt to discriminate between a receiving device and other foreign objects and to select one or more of the receiving devices for power transfer. After selecting one or more of the receiving devices, the WPT device 100 may proceed to the ping phase and collect information regarding the receiving device. If the WPT device 100 does not identify a suitable receiving device, the WPT device 100 may enter a low power stand-by mode of operation.

During the identification-and-configuration phase, the WPT device 100 prepares for power transfer to the receiving device. For this purpose, the WPT device 100 may retrieve relevant information from the receiving device. For example, the receiving device may communicate a charge status that indicates a power level of the receiving device. The WPT device 100 may combine this information with information that it stores internally to construct a power transfer protocol, which comprises various limits on the power transfer. During the power transfer phase, the WPT device 100 and the receiving device cooperate to regulate the transferred power to the desired level. For example, the receiving device may communicate its power needs at periodic intervals, and the WPT device 100 may continuously monitor the power transfer to ensure that the limits defined by the power transfer protocol are not violated. If a violation occurs, the WPT device 100 may abort the power transfer. At some point, the receiving device may indicate that charging is complete and the WPT device 100 may return to the stand-by mode.

FIG. 2 illustrates a cross-section of a coil assembly 200 formed in accordance with an embodiment. The coil assembly 128 (FIG. 1) may be similar or identical to the coil assembly 200. For reference, the coil assembly 200 is oriented with respect to an X-axis, a Y-axis, and a Z-axis that are mutually perpendicular to one another. The coil assembly 200 includes a flux-control body 202 and an electrical conductor 204 that is coupled to the flux-control body 202. In some embodiments, the flux-control body 202 is a pre-formed molded body having a binder material and ferromagnetic particles distributed within the binder material.

The flux-control body 202 may be configured to shield the electrical conductor 204 from other magnetic fluxes and/or shield nearby devices from the magnetic flux of the electrical conductor 204. The flux-control body 202 has a first body side 206 and a second body side 208 that face in generally opposite directions along the Z-axis. In the illustrated embodiment, the second body side 208 is generally flat or planar, and the first body side 206 is generally flat or planar, except for a coil-receiving recess 210 that opens to the first body side 206. In other embodiments, the second body side 208 may have a non-planar contour.

The coil-receiving recess 210 is a channel in the embodiment of FIG. 1 and, as such, is hereinafter referred to as the coil channel 210. The coil channel 210 has the electrical conductor 204 positioned therein. The cross-section of the coil assembly 200 in FIG. 2 shows multiple loops or windings of the same coil channel 210. These loops are referenced individually as 210A, 210B, 210C, but it is understood that the loops 210A-210C are portions of the same coil channel 210. The coil channel 210 forms a spiral-like path in which each loop turns about a central axis 212 that is parallel to the Z-axis. The loops 210A-210C may have a variety of shapes in order to achieve a target performance or a designated distribution of the magnetic flux. For example, when viewed along the Z-axis or central axis 212, the loops 210A-210C may be circular, oval-shaped, semi-circular, or rectangular (including square-shaped), triangular, or other polygonal shape.

The flux-control body 202 includes a shield wall 214 that defines the coil channel 210. In the illustrated embodiment, the coil channel 210 has an essentially rectangular cross-sectional profile for a majority of the coil channel 210. Because the shield wall 214 exists between adjacent loops of the coil channel 210, the coil channel 210 may also be characterized as defining the shield wall 214 or the shield wall 214 being defined between the loops. The shield wall 214 may have a predetermined thickness 291 measured along an XY plane to achieve a desired distribution of the magnetic flux within a spatial region 216 and/or to shield the electrical conductor 204 from unwanted interference. The spatial region 216 is a three-dimensional space adjacent to the first body side 206 of the flux-control body 202. The power-transfer space 114 (FIG. 1) may include at least a portion of the spatial region 216.

The electrical conductor 204 forms a power-transfer coil 220 having co-planar windings 220A, 220B, 220C that are positioned within the loops 210A, 210B, 210C, respectively. Similar to the coil channel 210, the windings 220A, 220B, 220C are portions of the same electrical conductor 204. The shield wall 214 is positioned directly between adjacent windings of the power-transfer coil 220 such that the adjacent windings are on opposite sides of the shield wall 214. The shield wall 214 separates the adjacent windings. The windings 220A-220C of the electrical conductor 204 generate a magnetic flux when current flows through the electrical conductor 204. The flux-control body 202 and the electrical conductor 204 (or power-transfer coil 220) are configured (e.g., sized, shaped, and positioned) with respect to one another to provide a designated distribution of the magnetic flux within the spatial region 216.

During wireless power transfer, a receiving device (not shown) may be positioned within the spatial region 216. The magnetic flux generated by the electrical conductor 204 may be shaped (or controlled) by the ferromagnetic material of the flux-control body 202. In particular, the electrical conductor 204 is positioned a depth within the coil channel 210 such that the shield wall 214 is positioned on each side of the electrical conductor 204. The shield wall 214 re-directs the magnetic flux and, as such, may be configured to determine how the magnetic flux is distributed within the spatial region 216. For example, the magnetic flux may be increased at designated portions of the spatial region 216 where, for instance, the coil of the receiving device may be positioned. It should be understood that other parameters may be configured or controlled to provide the designated distribution of the magnetic flux. For example, the current and/or voltage through the electrical conductor 204 may be controlled in order to obtain the designated distribution. The electrical conductor 204 may also have a width 205 that increases as the electrical conductor 204 moves further away from the central axis 212. In addition to the above, an outer rim section (described below) may be shaped to achieve the designated distribution of the magnetic flux.

In some embodiments, the power-transfer coil 220 may have only a single coil layer or level in which the electrical conductor 204 has only one set of co-planar windings. In the illustrated embodiment, however, the power-transfer coil 220 includes first and second coil layers or levels 224, 226 and, thus, two sets of co-planar windings. The first and second coil layers 224, 226 have different depths within the coil channel 210. Each of the first and second coil layers 224, 226 includes a plurality (or set) of corresponding co-planar windings. More specifically, the coil layer 224 includes the windings 220A, 220B, 220C, and the coil layer 226 includes the windings 220D, 220E, 220F. The windings 220D-220F are positioned within the loops 210A-210C, respectively.

The coil layers 224, 226 may be parts of the same electrical conductor 204. Thus, the electrical conductor 204 may also include the windings 220D-220F. Alternatively, the coil layers 224, 226 may be parts of different electrical conductors that are joined through, for example, a via that extends parallel to the central axis 212 through dielectric material (described below). As such, the windings 220A-220C and the windings 220D-220F may collectively form a single conductive pathway having the same electrical current flowing therethrough. In other embodiments, however, the windings 220A-220C may form one conductive pathway and the windings 220D-220F may form a separate conductive pathway such that the same electrical current does not flow through the conductive pathways. In FIG. 2, the coil assembly 200 includes two coil layers. It should be understood that other embodiments may include only one coil layer or more than two coil layers.

In some embodiments, a dielectric material 230 may be disposed within the coil channel 210 and extend along the electrical conductor 204. For example, the electrical conductor 204 may be a conductive trace that is formed along the dielectric material 230. The dielectric material 230 may form a first dielectric layer 232 and a second dielectric layer 234. The second coil layer 226 of the power-transfer coil 220 is positioned between the first and second dielectric layers 232, 234. The second dielectric layer 234 is disposed between the second coil layer 226 and a bottom surface 236 of the flux-control body 202 that defines the coil channel 210. Optionally, the second dielectric layer may not be used and the second coil layer 226 may be deposited directly onto the bottom surface 236. The first coil layer 224 is positioned along the first dielectric layer 232 and may form an exterior of the coil assembly 200. The first coil layer 224 may be covered by a housing, such as the system housing 110 (FIG. 1).

In FIG. 2, the first coil layer 224 of the electrical conductor 204 is located a depth within the coil channel 210. For example, first and second segments 242, 244 of the shield wall 214 may be positioned on opposite sides of the winding 220B of the electrical conductor 204. The shield wall 214 extends continuously from the bottom surface 236 to the first body side 206. The first and second segments 242, 244 may extend above the electrical conductor 204. In other embodiments, however, at least a portion of the electrical conductor 204 may clear and extend above the first and second segments 242, 244. As shown, the flux-control body 202 has an exterior side surface 240 that defines a portion of the first body side 206. The exterior side surface 240 may be continuous, except for discontinuities caused by the coil channel 210 opening along the first body side 206. The exterior side surface 240 may define a top surface of the shield wall 214.

In addition to the shield wall 214, the flux-control body 202 includes a center section 246, a base section 248, and an outer rim section 250. The central axis 212 extends through the center section 246. The loop 210A of the coil channel 210, which is the innermost loop, directly surrounds the center section 246. In FIG. 2, the center section 246 appears to include a center of the flux-control body 202. However, it should be understood that the center section 246 only represents a portion of the flux-control body 202 that is surrounded by the coil channel 210. The center section 246 may not include the center of the flux-control body 202 in other embodiments. For example, the outer rim section 250 may be larger in other embodiments such that the center section 246 does not include the center of the flux-control body 202. As another example, the flux-control body 202 may include multiple coil channels that are positioned separate from one another along an XY plane. The coil channels may have respective electrical conductors therein that form respective power-transfer coils. In such embodiments, the flux-control body 202 includes multiple center sections 246. The multiple power-transfer coils may form a coil array.

The base section 248 includes a portion of the second body side 208 and is defined between the coil channel 210 and the second body side 208. The shield wall 214 extends or projects from the base section 248 along the Z-axis (or the central axis 212). The base section 248 may have a predetermined thickness 292 measured along the Z-axis to achieve a desired distribution of the magnetic flux within the spatial region 216 and/or to shield the electrical conductor 204 from unwanted interference.

The outer rim section 250 surrounds the outermost loop 210C of the coil channel 210 and the outermost winding 220C of the electrical conductor 204. The outer rim section 250 may include a portion of the second body side 208. The outer rim section 250 may have a predetermined radial thickness 293 (or radial dimension) measured along the XY plane to achieve a designated distribution of the magnetic flux within the spatial region 216 and/or to shield the electrical conductor 204 from unwanted interference. In the illustrated embodiment, the outer rim section 250 has substantially uniform cross-sectional dimensions and the exterior side surface 240 is planar along the outer rim section 250. As described with respect to the embodiment of FIG. 4, however, the outer rim section 250 may have a contoured surface in other embodiments that is configured to re-direct the magnetic flux to achieve a designated distribution.

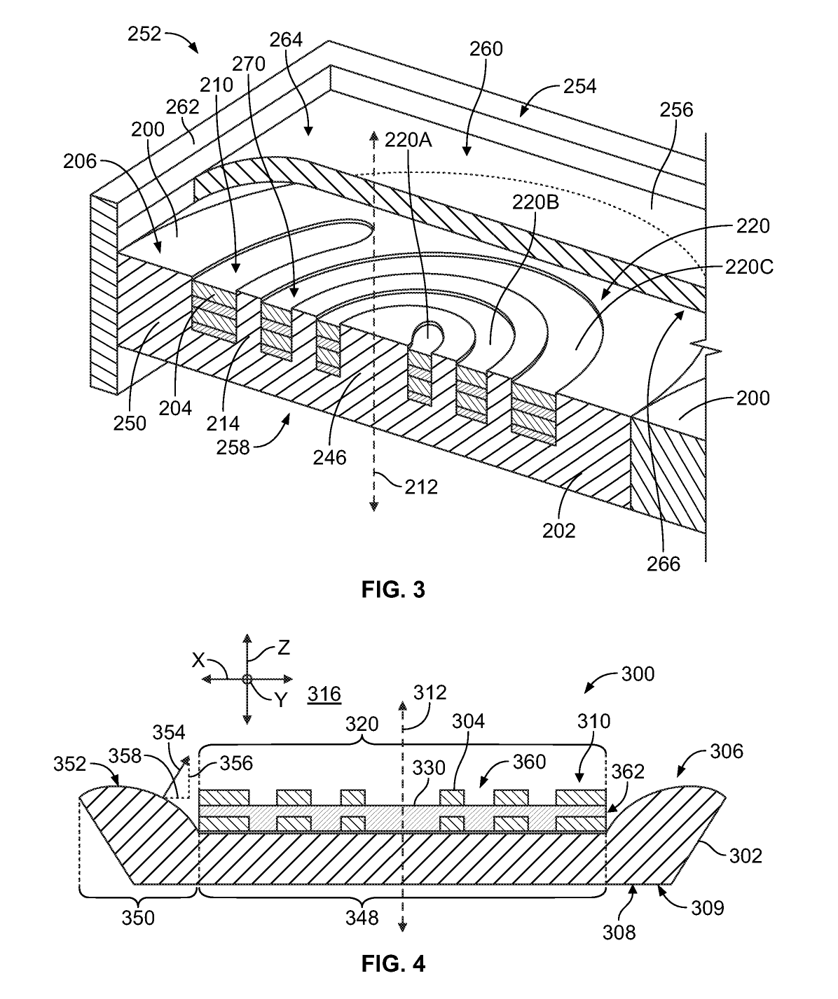

FIG. 3 is a perspective view of a cross-section of a WPT system 252 in accordance with an embodiment that includes at least two coil assemblies 200 and a system housing 254. The system housing 254 includes a stage wall 256 that separates a coil-positioning space 258 of the system housing 254 and an external space 260 of the system housing 254. In the illustrated embodiment, the external space 260 is also defined by a sidewall or rim 262. The stage wall 256 has a charging surface 264 that faces the external space 260 and an inner surface 266 that faces the coil-positioning space 258. In some embodiments, the coil-positioning space 258 may be an interior cavity of the system housing 254 that is not generally accessible during normal operation of the WPT system 252.

Also shown, the coil assemblies 200 may be positioned side-by-side within the coil-positioning space 258. Cross-sections of the coil assemblies 200 are shown, but only a small portion of one of the coil assemblies 200 is illustrated. The coil assemblies 200 are disposed adjacent to the inner surface 266 of the stage wall 256. More specifically, the first body side 206 is positioned adjacent to the inner surface 266 so that the magnetic flux generated by the coil assembly 200 may extend into the external space 260 for transferring power to devices positioned therein.

As shown by the perspective view, the shield wall 214 extends from the center section 246 and forms a spiral-like path that turns about the central axis 212. The shield wall 214 defines the coil channel 210. The adjacent windings 220A, 220B, 220C of the power-transfer coil 220 are positioned on opposite sides of the shield wall 214. However, the outer rim section 250 is positioned adjacent to only one winding (the winding 220C) of the power-transfer coil 220.

The coil channel 210 opens to the first body side 206 to an exterior of the flux-control body 202 and toward the inner surface 266. Optionally, the electrical conductor 204 (or the power-transfer coil 220) may be spaced apart from the inner surface 266 such that at least a nominal gap exists therebetween during the intended commercial operation of the coil assembly 200. The nominal gap may be filled with air or may have, for example, an adhesive disposed therein that facilitates coupling the coil assembly 200 to the stage wall 256. In such embodiments, the windings 220A-220C may be exposed to the exterior of the flux-control body 202 along the first body side 206. More specifically, the windings 220A-220C (or the power-transfer coil 220) define a portion of an exterior surface 270 of the coil assembly 200. The exterior surface 270 may also include portions of the flux-control body 202. In other embodiments, however, the windings 220A-220C may be covered with a material that forms a portion of the coil assembly 200. The additional material may be discrete with respect to the flux-control body. For example, the windings 220A-220C may be covered with a layer of dielectric material or other material that does not substantially impede the magnetic flux during the intended commercial operation of the coil assembly 200. The layer of dielectric material may form a portion of the exterior surface 270 in such embodiments.

Alternatively, the electrical conductor 204 may be pressed against the inner surface 266 during the intended commercial operation of the coil assembly 200. Nevertheless, in such embodiments, the electrical conductor 204 may be discrete with respect to the stage wall 256 such that the windings 220A, 220B, 220C are exposed to the exterior of the flux-control body 202 along the first body side 206 and define a portion of the exterior surface of the coil assembly 200. In such embodiments, the coil channel 210 opens along the first body side 206, although the coil channel 210 may be enclosed by the inner surface 266.

In FIG. 3, the inner surface 266 is essentially planar. In other embodiments, the inner surface 266 may have a non-planar contour or shape. In such embodiments, the flux-control body 202 may be at least one of (a) shaped to substantially match the contour of the inner surface 266 or (b) be sufficiently flexible such that the flux-control body 202 may conform to the shape of the inner surface 266. Moreover, a flexible flux-control body 202 may ease the process of positioning the coil assembly 200 within the coil-positioning space 258, because the flux-control body 202 may bend to allow positioning.

FIG. 4 illustrates a cross-section of a coil assembly 300 formed in accordance with an embodiment. The coil assembly 128 (FIG. 1) may be similar or identical to the coil assembly 300. The coil assembly 300 may have features that are similar or identical to the features of the coil assembly 200 (FIG. 2). The coil assembly 300 includes a flux-control body 302 and a printed circuit 360 that is coupled to the flux-control body 302. In particular embodiments, the flux-control body 302 may be a pre-formed molded body having a binder material and ferromagnetic particles distributed within the binder material. The printed circuit 360 may be, for example, a printed circuit board (PCB) or a flex circuit. The printed circuit 360 may also be formed through laser direct structuring (LDS), insert molding, two-shot molding (dielectric with copper traces), and/or screen-printing.

The flux-control body 302 has first and second body sides 306, 308 that face in generally opposite directions along the Z-axis. The first body side 306 forms a coil-receiving recess 310 having a printed circuit 360 disposed therein. The printed circuit 360 includes an electrical conductor 304. Similar to the electrical conductor 204 (FIG. 2), the electrical conductor 304 has a plurality of co-planar windings and forms a power-transfer coil 320 that is configured to generate a magnetic flux within a spatial region 316 that is adjacent to the first body side 306. Similar to the electrical conductor 204 (FIG. 2), the windings of the electrical conductor 304 may have a variety of shapes. For example, the windings may be circular, oval-shaped, semi-circular, rectangular (including square-shaped), triangular, or other polygonal.

The flux-control body 302 includes a base section 348 that includes the second body side 308 and an outer rim section 350 that surrounds the coil-receiving recess 310, which opens to the first body side 306. The base section 348 may include a bottom surface 349 that defines a portion of the coil-receiving recess 310. The bottom surface 349 may be essentially planar or have non-planar contours in alternative embodiments. In some embodiments, the coil-receiving recess 310 is sized and shaped to receive the printed circuit 360 as a single unitary structure. For example, the printed circuit 360 may be manufactured separately and then positioned, as a unit, within the coil-receiving recess 310. As such, the outer rim section 350 and the printed circuit 360 may be dimensioned such that the printed circuit 360 is fitted within the coil-receiving recess 310. More specifically, the printed circuit 360 may have an outer edge 362 that engages the outer rim section 350 or other non-planar feature of the flux-control body 302 to locate the printed circuit 360 at a designated position.

The printed circuit 360 may be manufactured through a variety of fabrication technologies. For example, the printed circuit 360 may be manufactured through known printed circuit board (PCB) technologies. The printed circuit 360 may be a laminate or sandwich structure that includes a plurality of stacked substrate layers. Each substrate layer may include, at least partially, an insulating dielectric material. By way of example, the substrate layers may include a dielectric material (e.g., flame-retardant epoxy-woven glass board (FR4), FR408, polyimide, polyimide glass, polyester, epoxy-aramid, metals, and the like); a bonding material (e.g., acrylic adhesive, modified epoxy, phenolic butyral, pressure-sensitive adhesive (PSA), pre-impregnated material, and the like); a conductive material that is disposed, deposited, or etched in a predetermined manner; or a combination of the above. The conductive material may be copper (or a copper-alloy), cupro-nickel, silver epoxy, conductive polymer, and the like. The dielectric material may be rigid or flexible. It should be understood that substrate layers may include sub-layers of, for example, bonding material, conductive material, and/or dielectric material. In FIG. 4, the conductive material forms the electrical conductor 304 and a dielectric material 330 is formed from the substrate layers. The electrical conductor 304 may also be referred to as a conductive trace.

The outer rim section 350 has a contoured surface 352 that faces in a flux-control direction 354. The flux-control direction 354 includes a Z-component 356 that is parallel to the Z-axis and a XY-component 358. The flux-control direction 354 is perpendicular to a tangent of the contoured surface 352 at a point along the contoured surface. The XY-component is perpendicular to the Z-component 356. The contoured surface 352 is shaped to control a distribution of the magnetic flux experienced within the spatial region 316. For example, the contoured surface 352 is non-planar and an area closest to the printed circuit 360 generally faces a central axis 312.

As shown in FIG. 4, the contoured surface 352 may be curved. In other embodiments, however, the contoured surface 352 may include one or more areas that are planar. In an exemplary embodiment, the contoured surface 352 is symmetrical about the central axis 312 such that the shape of the contoured surface 352 is uniform around the central axis 312. In other embodiments, however, the contoured surface 352 may not be symmetrical about the central axis 312.

The second body side 308 and/or the outer rim section 350 is defined by an exterior surface 309. As shown, the exterior surface 309 is similar to an exterior surface of a cup or bowl. In alternative embodiments, the exterior surface 309 may have other shapes. For instance, the exterior surface 309 may be shaped to include one or more features (e.g., recesses and/or projections) that engage other components of a WPT device. As one particular example, the exterior surface 309 may be shaped to form an interference fit with a system housing or other component of the WPT device.

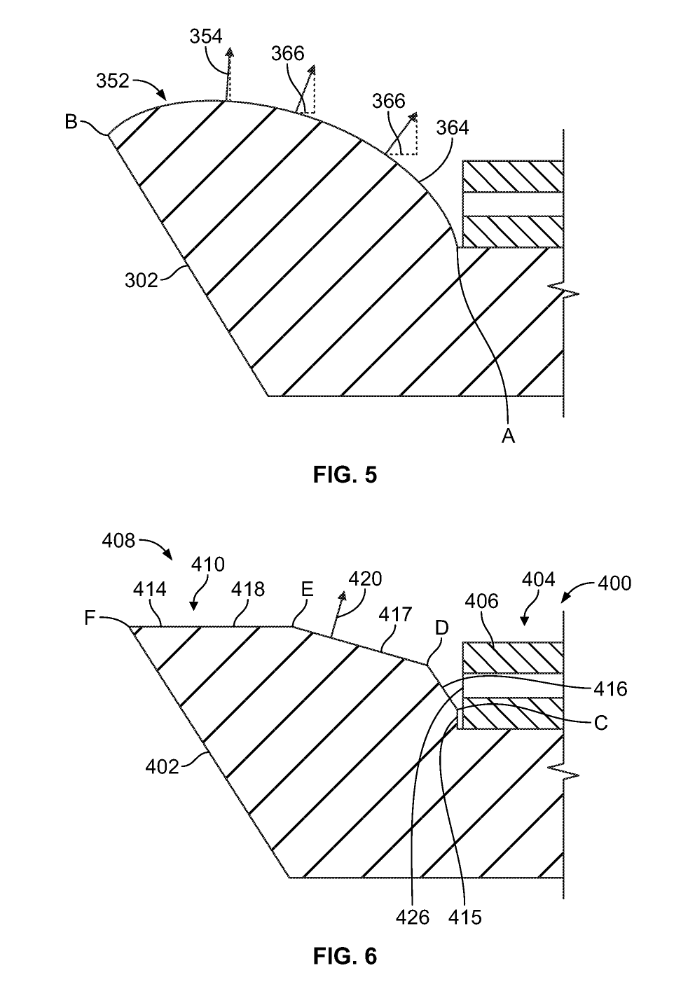

FIG. 5 is an enlarged view of the cross-section of the flux-control body 302 and illustrates in greater detail a cross-sectional profile of the contoured surface 352. The contoured surface 352 includes a designated rim area 364. Only a single cross-sectional profile of the rim area 364 is shown in FIG. 5, but the rim area 364 extends at least partially around the central axis 312 (FIG. 4). The rim area 364 is non-planar and, in the illustrated embodiment, is curved such that the rim area 364 curves continuously from point A to point B. Points A and B in FIG. 5 may have different locations in other embodiments. Point B may be positioned along an edge of the flux-control body 302. As shown, the flux-control direction 354 changes as the rim area 364 extends further away from the central axis 312. More specifically, an XY component 366 decreases as the rim area 364 extends away from the central axis 312.

In alternative embodiments, the flux-control direction 354 may change in other manners. For instance, the XY component 366 may decrease at a greater or lesser rate than shown in FIG. 5. As another example, the cross-sectional profile of the rim area 364 (or the contoured surface 352) in FIG. 5 has a convex shape. In alternative embodiments, the cross-sectional profile of the rim area 364 (or the contoured surface 352) may have a concave shape.

FIG. 6 is an enlarged view of a cross-section of a coil assembly 400 in accordance with an embodiment. The coil assembly 400 may be used as the coil assembly 128 (FIG. 1). The coil assembly 400 includes a flux-control body 402 and a printed circuit 404 having an electrical conductor 406. The coil assembly 400 may have features that are similar or identical to features of the coil assembly 200 (FIG. 2) or the coil assembly 300 (FIG. 4).

The flux-control body 402 includes an outer rim section 408 having a contoured surface 410. FIG. 6 illustrates a cross-sectional profile of the contoured surface 410. The contoured surface 410 includes a designated rim area 414. Only a single cross-sectional profile of the rim area 414 is shown in FIG. 6, but the rim area 414 extends at least partially around the central axis 312 (FIG. 4). Viewed in its entirety, the rim area 414 is non-planar, but includes a plurality of planar sub-areas 415, 416, 417, 418. The rim area 414 includes a positioning sub-area 415 that is configured to interface with an edge 426 of the printed circuit 404. The positioning sub-area 415 may engage or be located immediately adjacent to the edge 426. The positioning sub-area 415 may facilitate locating the printed circuit 404 at a designated position with respect to the flux-control body 402.

The rim area 414 also includes a first sub-area 416 that extends from point C to point D, a second sub-area 417 that extends from point D to point E, and a third sub-area 418 that extends from point E to point F. Each of the first, second, and third sub-areas 416-418 is essentially planar. However, each of the first, second, and third sub-areas 416-418 faces in a different respective direction. For example, a flux-control direction 420 along the second sub-area 417 has a greater XY-component than the flux-control direction 420 along the third sub-area 418 but a smaller XY-component than the flux-control direction 420 along the first sub-area 416. In alternative embodiments, one or more of the sub-areas 415-418 may be curved (e.g., convex or concave).

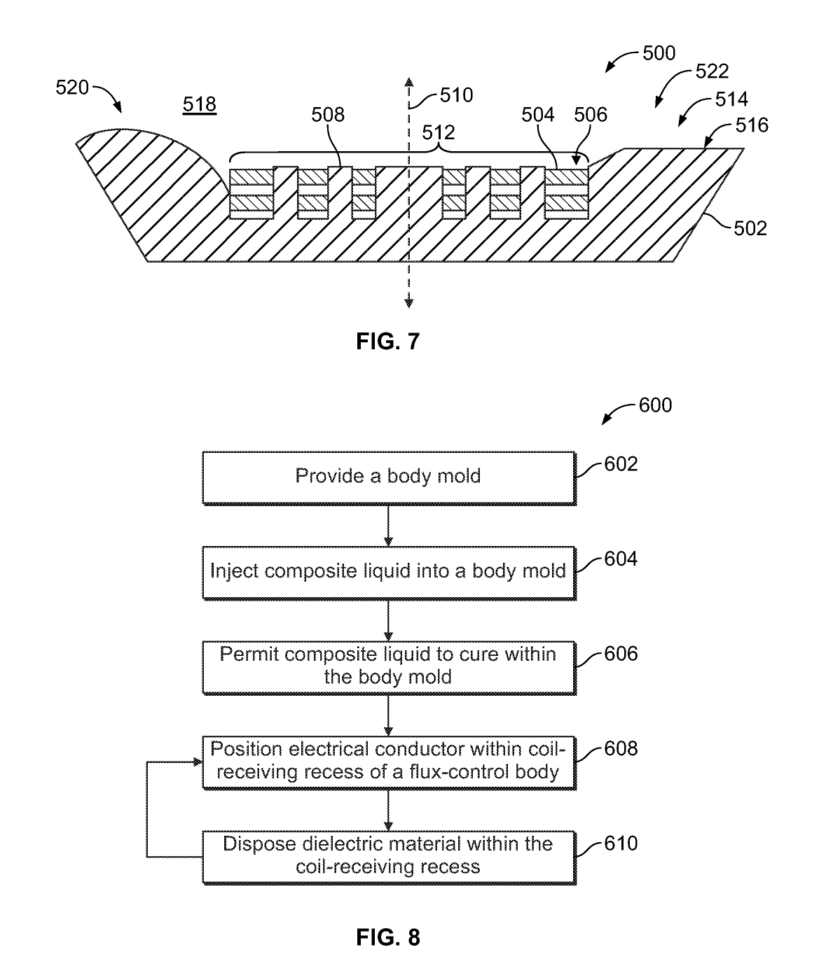

FIG. 7 is a cross-sectional view of a coil assembly 500 in accordance with an embodiment. The coil assembly 500 may be used as the coil assembly 128 (FIG. 1) and may include features that are similar to the features of other coil assemblies described herein. The coil assembly 500 includes a flux-control body 502 and an electrical conductor 504 that is positioned within a coil channel 506 of the flux-control body 502. The coil channel 506 may be similar to the coil channel 210 (FIG. 2). The flux-control body 502 includes a shield wall 508 that may be similar to the shield wall 214 (FIG. 2). The electrical conductor 504, the coil channel 506, the shield wall 508 wind about a central axis 510 such that the electrical conductor 504 forms a power-transfer coil 512. Adjacent windings of the electrical conductor 504 are separated by the shield wall 508. The coil assembly 500 also includes an outer rim section 514 having a contoured surface 516. In such embodiments, the shield wall 508 and the outer rim section 514 may be configured to relative to each other to control the distribution of the magnetic flux experienced within a spatial region 518.

As described herein, one or more embodiments may include a contoured surface that is symmetrical about a central axis such that a cross-sectional profile of the contoured surface is uniform about the central axis. In other embodiments, however, the contoured surface may have a cross-sectional profile that changes. For example, the contoured surface 516 may include a first cross-sectional profile 520 that is identical to the cross-sectional profile of FIG. 5 and a second cross-sectional profile 522 that is similar to (but different from) the cross-sectional profile of FIG. 6. In some embodiments, the different portions of the contoured surface 516 along the first and second cross-sectional profiles 520, 522 may oppose each other such that a single cross-section that includes the central axis 510 also includes each of the first and second cross-sectional profiles 520, 522. In other embodiments, the first and second cross-sectional profiles 520, 522 are taken along different planes that include the central axis 510. In some embodiments, the transition between different cross-sectional profiles of the contoured surface is gradual. In other embodiments, the transition between different cross-sectional profiles of the contoured surface may be immediate or abrupt.

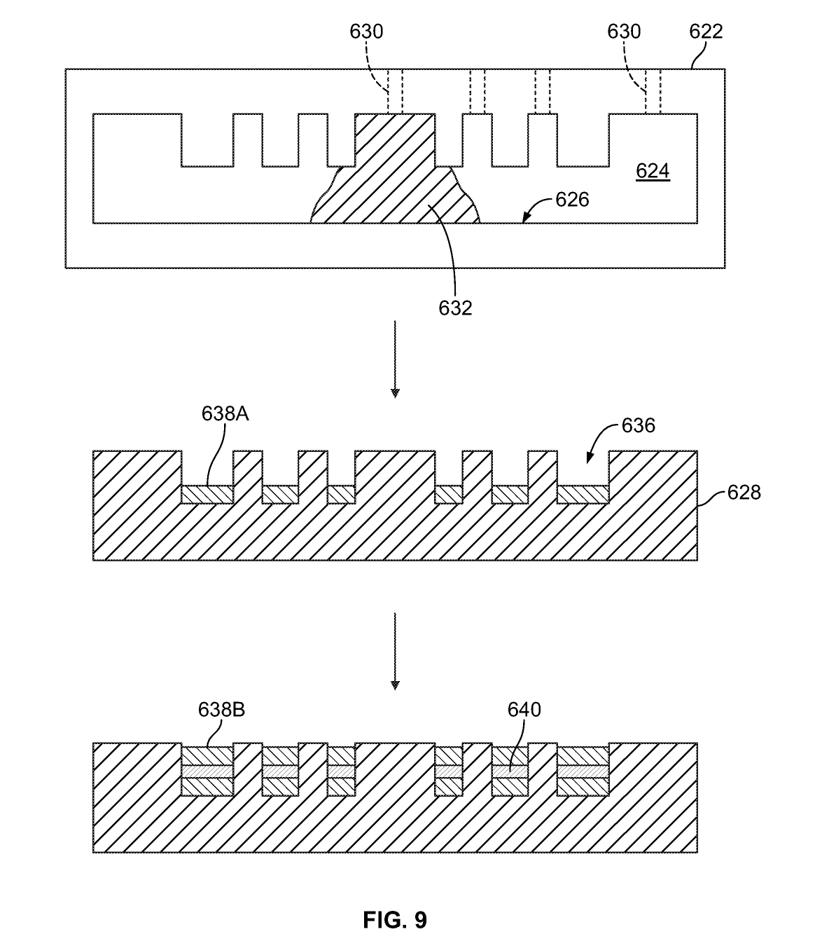

FIG. 8 is a flowchart illustrating a method 600 of manufacturing or fabricating a coil assembly, such as the coil assembly 128 (FIG. 1), the coil assembly 200 (FIG. 2), the coil assembly 300 (FIG. 4), the coil assembly 400 (FIG. 6), or the coil assembly 500 (FIG. 7). FIG. 9 illustrates different stages or steps of the method 600. The method 600 may include, for example, providing, at 602, a body mold 622 having an interior cavity 624 that is shaped by interior surfaces 626 of the body mold 622. For example, the interior surfaces 626 may be shaped to provide a flux-control body 628 that is similar or identical to the flux-control bodies described herein. The body mold 622 includes passages 630 that provide fluidic access to the cavity 624. At least one of the passages 630 may allow a composite resin to be injected therein and at least one other passage 630 may allow gas within the cavity 624 to be displaced while the composite resin is injected.

The method 600 also includes injecting, at 604, a composite liquid 632 into the interior cavity 624. As described above, the composite liquid 632 may include a binder material and ferromagnetic particles distributed therein. At 606, the composite liquid 632 may be cured within the body mold 622 such that the composite liquid solidifies or becomes more rigid. After curing, the flux-control body 628 is provided that includes a coil-receiving recess 636 as described above. In the illustrated embodiment, the coil-receiving recess 636 is a coil channel.

At 608, an electrical conductor 638 may be positioned within the coil-receiving recess 636. At 610, a dielectric material 640 may be positioned within the coil-receiving recess 636. It should be understood that step 608 may occur prior to step 610, after step 610, or simultaneously with step 610.

As another example, the electrical conductors 638A, 638B and the dielectric material 640 may be simultaneously provided by disposing a printed circuit within the coil-receiving recess that includes the electrical conductors 638A, 638B and the dielectric material 640. In some embodiments, the printed circuit may be shaped to match the coil-receiving recess. For example, the printed circuit may be formed through a separate molding process. The printed circuit may be molded to have a shape that is similar or identical to the shape of the coil-receiving recess. As another example, a printed circuit (e.g., PCB or flex circuit) may be manufactured and then cut or etched to have a shape that is similar or identical to the shape of the coil-receiving recess.

Yet in other embodiments, the coil assembly may be formed through insert molding. For example, the power-transfer coil may be disposed within the body mold 622 such that the electrical conductor 638 is pressed against the interior surface 626 of the body mold 622. A composite resin may be injected into the cavity 624 and permitted to surround only a portion of the electrical conductor 638. After the flux-control body is cured, the coil assembly may be removed with the electrical conductor 638 forming a portion of an exterior surface of the coil assembly.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The patentable scope should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. A coil assembly comprising:
a flux-control body comprising a magnetic material and having a body side, the flux-control body including a shield wall that defines a coil channel of the flux-control body that opens along the body side to an exterior of the flux-control body; and
an electrical conductor positioned within the coil channel, the electrical conductor forming a power-transfer coil having co-planar windings that are configured to generate a magnetic flux within a spatial region that is adjacent to the body side, wherein the shield wall of the flux-control body is positioned directly between adjacent windings of the power-transfer coil, the shield wall controlling a distribution of the magnetic flux experienced within the spatial region.

2. The coil assembly of claim 1, wherein the flux-control body is a pre-formed molded body comprising a binder material and ferromagnetic particles distributed within the binder material.

3. The coil assembly of claim 2, wherein the flux-control body further comprises a dielectric material disposed within the coil channel, the electrical conductor comprising a conductive trace that is formed within the coil channel along the dielectric material.

4. The coil assembly of claim 3, wherein the dielectric material forms a first dielectric layer and a second dielectric layer, the power-transfer coil including first and second coil layers that each include a plurality of corresponding co-planar windings, wherein the first coil layer is positioned between the first and second dielectric layers, the second coil layer being positioned along the second dielectric layer, the second dielectric layer being disposed between the first and second coil layers.

5. The coil assembly of claim 3, wherein the conductive trace is located a depth within the coil channel such that first and second segments of the shield wall are positioned on opposite sides of the conductive trace and clear and extend above the conductive trace.

6. The coil assembly of claim 1, wherein the windings are exposed to an exterior of the flux-control body such that the windings form a portion of an exterior surface of the coil assembly.

7. The coil assembly of claim 1, wherein the body side is a first body side, the flux-control body including a base section that defines a second body side that is opposite the first body side, the shield wall extending from the base section, the base section separating the coil channel from the second body side.

8. The coil assembly of claim 1, wherein the coil channel has an essentially rectangular cross-sectional profile for a majority of the coil channel.

9. A wireless-power transfer (WPT) system comprising:
a system housing having a stage wall that separates a housing cavity of the system housing from an external space of the system housing, the stage wall having a charging surface that faces the external space and an interior surface that faces the housing cavity;
a coil assembly disposed within the housing cavity adjacent to the interior surface of the stage wall, the coil assembly comprising:
a flux-control body comprising a ferromagnetic material and having a body side that faces the interior surface of the stage wall, the flux-control body including a shield wall that defines a coil channel of the flux-control body that opens along the body side to an exterior of the flux-control body and toward the interior surface; and
an electrical conductor positioned within the coil channel, the electrical conductor forming a power-transfer coil having co-planar windings that are configured to generate a magnetic flux within a spatial region that extends into the external space of the system housing, wherein the shield wall of the flux-control body is positioned directly between adjacent windings of the power-transfer coil, the shield wall controlling a distribution of the magnetic flux experienced within the spatial region.

10. The WPT system of claim 9, wherein the flux-control body is a pre-formed molded body comprising a binder material and ferromagnetic particles distributed within the binder material.

11. The WPT system of claim 10, wherein the flux-control body further comprises a dielectric material disposed within the coil channel, the electrical conductor comprising a conductive trace that is formed within the coil channel along the dielectric material.

12. The WPT system of claim 11, wherein the dielectric material forms a first dielectric layer and a second dielectric layer, the power-transfer coil including first and second coil layers that each include a plurality of corresponding co-planar windings, wherein the first coil layer is positioned between the first and second dielectric layers, the second coil layer being positioned along the second dielectric layer, the second dielectric layer being disposed between the first and second coil layers.

13. The WPT system of claim 11, wherein the conductive trace is located a depth within the coil channel such that first and second segments of the shield wall are positioned on opposite sides of the conductive trace and clear and extend above the conductive trace.

14. The WPT system of claim 9, wherein the windings are exposed to an exterior of the flux-control body such that the windings form a portion of an exterior surface of the coil assembly.

15. The WPT system of claim 9, wherein the body side is a first body side, the flux-control body including a base section that defines a second body side that is opposite the first body side, the shield wall extending from the base section, the base section separating the coil channel from the second body side.

16. The WPT system of claim 9, wherein the coil channel has an essentially rectangular cross-sectional profile for a majority of the coil channel.

17. A method of manufacturing a coil assembly, the method comprising:
providing a body mold having an interior cavity that is shaped by interior surfaces;
injecting a composite liquid into the interior cavity, the composite liquid including a binder material and ferromagnetic particles distributed therein;
permitting the composite liquid to cure within the body mold, thereby providing a flux-control body, the flux-control body having a body side and a shield wall that defines a coil channel of the flux-control body that opens along the body side to an exterior of the flux-control body; and
positioning an electrical conductor within the coil channel, the coil channel being shaped to form a power-transfer coil when the electrical conductor is positioned therein, the power-transfer coil having co-planar windings that are configured to generate a magnetic flux within a spatial region that is adjacent to the body side, wherein the shield wall of the flux-control body is positioned directly between adjacent windings of the power-transfer coil, the shield wall controlling a distribution of the magnetic flux experienced within the spatial region.

18. The method of claim 17, wherein the flux-control body comprises a binder material and ferromagnetic particles distributed within the binder material.

19. The method of claim 18, further comprising disposing a dielectric material within the coil channel, the electrical conductor comprising a conductive trace that is formed within the coil channel along the dielectric material.

20. The method of claim 17, wherein the electrical conductor is located a depth within the coil channel such that first and second segments of the shield wall are positioned on opposite sides of the electrical conductor and clear and extend above the electrical conductor.
